(19) United States
(12) Patent Application Publication
(10) Pub. No.: US 2004/0149843 A1
(43) Pub. Date: Aug. 5, 2004

(54) Chopping apparatus

(76) Inventor: Ling Kwong Tang, Hong Kong (HK)

Correspondence Address: SMITH-HILL AND BEDELL, 12670 N W BARNES ROAD, SUITE 104, PORTLAND, OR, 97229

(21) Appl. No.: 10/356,052

(22) Filed: Jan. 31, 2003

(51) Int. Cl. A47J 43/044

(52) U.S. Cl. 241/272

(57) ABSTRACT

A chopping apparatus is disclosed as including an actuating rod with a head portion at a first end and a blade at a second end, in which the actuating rod is movable along its longitudinal axis, and a cushion made of a thermoplastic elastomer is fixedly secured to the head portion of the actuating rod so that the cushion is not movable relative to the head portion of the actuating rod.

This invention relates to a chopping apparatus in which the item to be chopped is contained in a chamber of the apparatus during chopping and is chopped by a blade which exhibits reciprocating upward and downward movements.

### BACKGROUND OF THE INVENTION

There are in existence a number of chopping apparatus, e.g. for chopping up food, as shown in British Patent Publication No. GB 2 287 174 A (Lam) and U.S. Patent Publication No. 2002/0113155 A1 (Weibel et al.), the contents of which being fully incorporated herein for reference.

During the chopping operation, usually a palm of a user presses on a top part of an actuator of the apparatus to cause a blade to descend into the chamber to chop the item, e.g. food, in the chamber. When the downward pressure of the palm is released, the blade and the actuator will move upward upon the biasing force of a spring in the apparatus. By means of the mechanism disclosed in Lam, the blade can rotate incrementally about a longitudinal axis of the apparatus. However, a disadvantage associated with such a type of chopper is that the hand of the user will experience significant reaction force every time the blade comes into contact with the bottom of the chamber, and reaches the limit of its upward movement.

Weibel et al. thus proposes to insert in the upper portion and on the top surface of the actuation head parts made of a material which is softer than the material of the upper portion or respectively of the actuation head. According to Weibel et al., such can ensure that the chopper can be securely held by the user's hand, and the soft part inserted on the top part on the actuation head can damp the blow exerted by the hand on chopping.

However, as can be clearly seen in FIG. 4 of Weibel et al., there is a space between the top surface of the actuation head and the cap. It is said that the air cushion resulting from this hollow space supports the damping effect of the soft material of the spherical cap. It is, nevertheless, found in practice that, during operation, the spherical cap will move into and out of the space. In particular, when the actuation head is moved downward, the cap will deform and move into the hollow space, and when the downward pressure is released, the cap will return to is normal shape as shown in FIG. 4 of Weibel et al. The spherical cap will thus be easily damaged due to such repeated changes in its shape.

In addition, Weibel et al. indicates that the flexibility of the material of the spherical cap makes it possible for the cap to be removed from the actuation head. Such a possibility, on the other hand, enhances the chance of losing the cap.

It is thus an object of the present invention to provide a chopper in which the aforesaid shortcomings are mitigated, or at least to provide a useful alternative to the public.

It is a further object of the present invention to provide a chopper which can reduce the shock experienced by a user during operation, and yet can withstand repeated operation.

It is a yet further object of the present invention to provide a chopper which can reduce the shock experienced by a user during operation, and the components are not easily lost.

### SUMMARY OF THE INVENTION

According to the present invention, there is provided a chopping apparatus including an actuator with a head portion at a first longitudinal end and a blade at a second longitudinal end, wherein said actuator is adapted to reciprocate along its longitudinal axis, and wherein a cushion member made of a material which is softer than the material of which said head portion is made is secured to said head portion of said actuator against relative movement therebetween.

### BRIEF DESCRIPTION OF THE DRAWINGS

A preferred embodiment of the present invention will now be described, by way of example only, with reference to the accompanying drawings, in which:

FIG. 1 is a perspective exploded view of a chopper according to the present invention;

FIG. 2 is a perspective exploded view of the chopper shown in FIG. 1 in which the blade guard is engaged with the housing;

FIG. 3A is a perspective view of the chopper shown in FIG. 1 as assembled, with the actuating rod in its uppermost position;

FIG. 3B is a perspective view of the chopper shown in FIG. 3A, with the actuating rod in its lowermost position;

FIG. 4A is a perspective view of the upper end of the actuating rod of the chopper shown in FIG. 1, secured with a cushion; and

FIG. 4B is a longitudinal sectional view of the upper end of the actuating rod and cushion shown in FIG. 4A.

### DETAILED DESCRIPTION OF THE PREFERRED EMBODIMENT

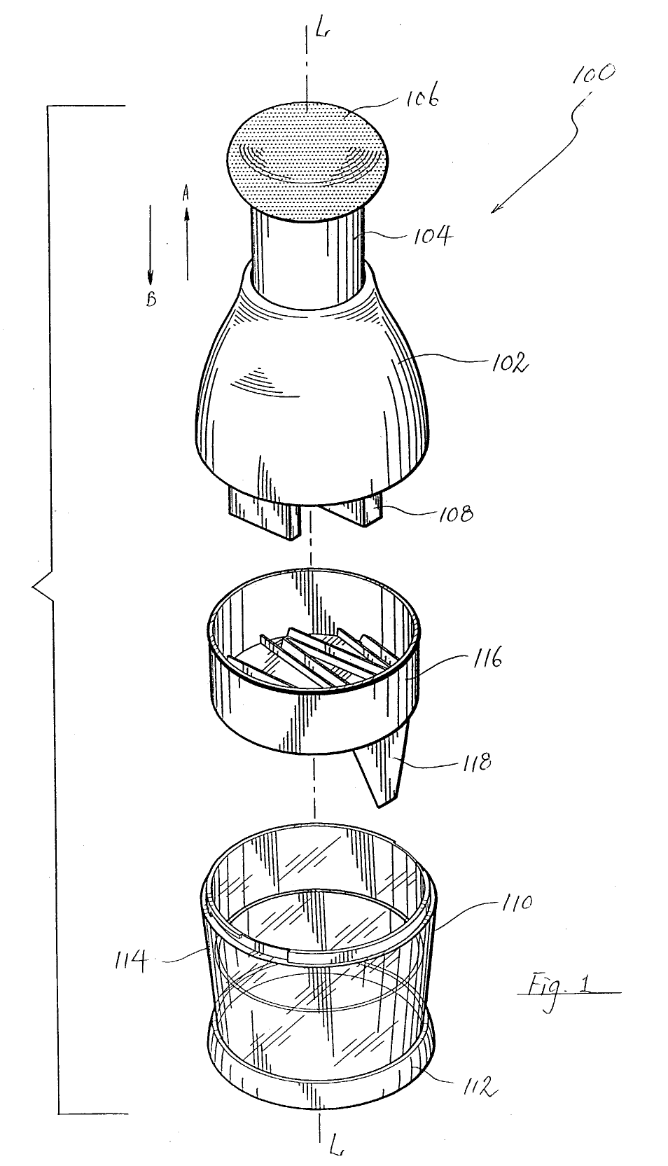

A chopper according to the present invention is shown in FIG. 1, and generally designated as 100. The chopper 100 includes a housing 102 and a longitudinal actuating rod 104 which can exhibit reciprocating movement relative to the housing 102 along a longitudinal axis L-L of the apparatus 100, and of the rod 104. On a top end of the rod 104, which is made of acrylonitrile butadiene styrene resin (ABS), is provided with a cushion 106, further details of which to be discussed below. On a bottom end of the rod 104 is mounted a chopping blade 108 for simultaneous movement with the rod 104. When the rod 104 is in the position shown in FIG. 1, a part of the blade 108 is housed within the housing 102.

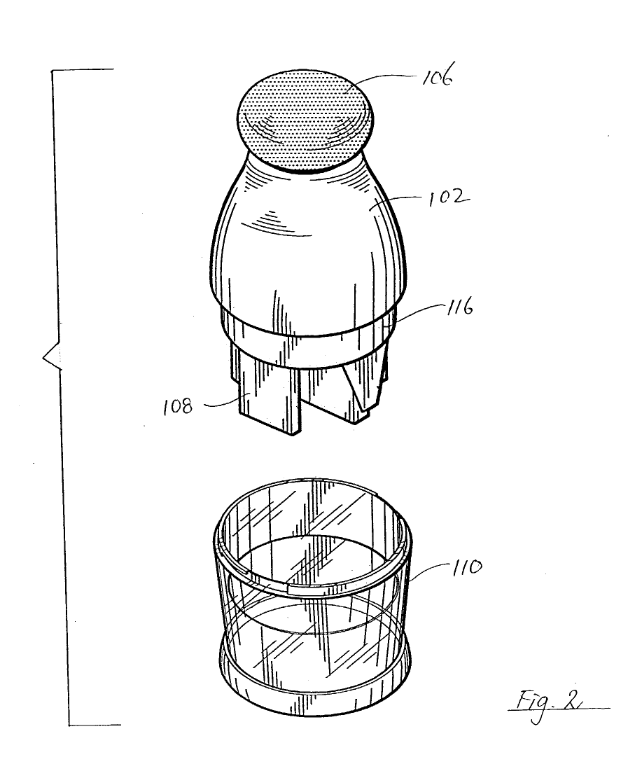

The chopper 100 also includes a base 110 with a bottom 112 and a generally cylindrical transparent wall 114. The base 110 is engageable with the housing 102 to form a cavity for receiving items, e.g. food, to be chopped. Positioned between the base 110 and the housing 102 is a removable blade guard 116 which, when the rod 104 is in the position as shown in FIG. 1, effectively encloses the whole of the blade 108. The blade guard 116 includes slots 118 through which the blade 108 extends when the rod 104 is pushed, e.g. when the cushion 106 is pressed down in the direction of the arrow B shown in FIG. 1 relative to the blade guard 116, as shown in FIG. 2. The blade 108 may then descend into the cavity formed by the housing 102 and the base 110. The blade guard 116 also includes a wiper 118 which moves along and close to the inner surface of the wall 114 to wipe the chopped material away from the wall 114, also as not to obscure the interior of the cavity from sight.

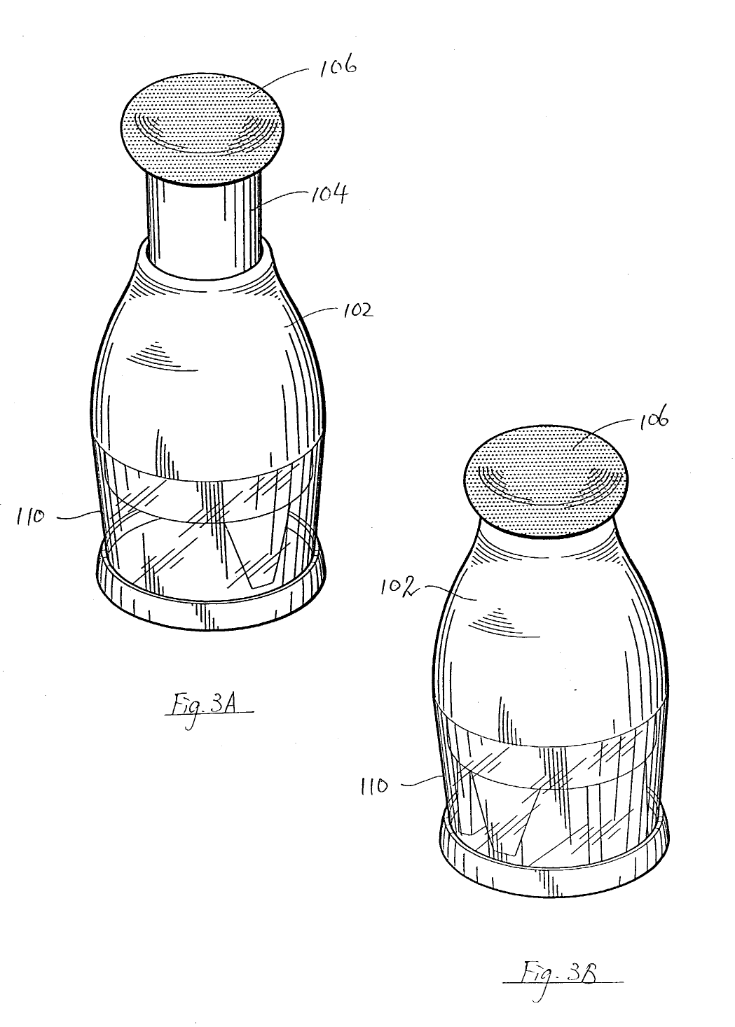

The rod 104, together with the cushion 106 and the blade 108, may be operated to reciprocate in the direction indicated by the arrows A and B shown in FIG. 1, between the position shown in FIG. 3A, in which the cushion 106 is farthest away from the housing 102, and the position shown in FIG. 3B, in which the cushion 106 is closely adjacent to the housing 102. Housed within the housing 102 is a spring (not shown) which biases the rod 104 to the position shown in FIG. 1.

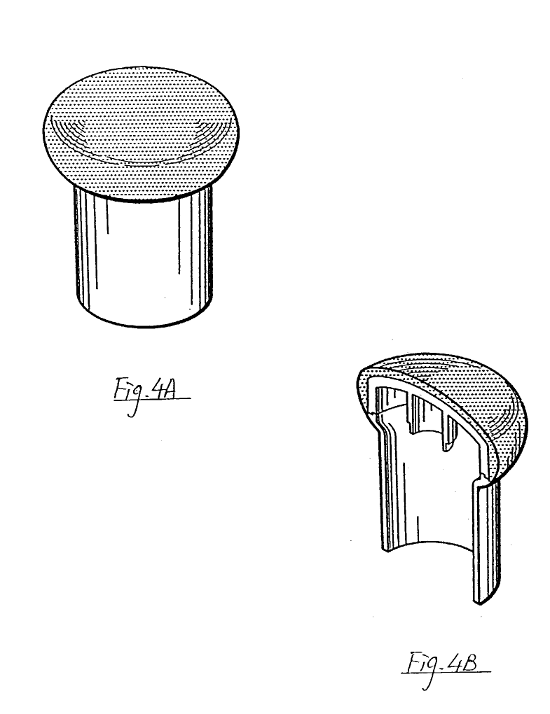

As discussed above, and as shown in FIG. 4A, a top end of the rod 104 is provided with a cushion 106, which is made of a thermoplastic elastomer, e.g. one traded by Advanced Elastomer Systems, L.P., of Akron, Ohio, United States of America under their trade mark “SANTOPRENE”. The cushion 106 is tightly and fixedly secured to the rod 104, e.g. by ultrasonic moulding, so that the two are not movable relative to each other. In particular, the cushion 106 cannot be removed from the rod 104, unless either is damaged. It can be seen clearly in FIG. 4B that there is no cavity or space between the rod 104 and the cushion 106. In this way, the cushion 106 will not undergo deformations during operation, and thus the structural integrity of the cushion 106 is maintained.

It should be understood that the above only illustrates an example whereby the present invention may be carried out, and that various modifications and/or alterations may be made thereto without departing from the spirit of the invention.

It should also be understood that various features of the invention which are, here for brevity, described in the context of a single embodiment, may be provided separately or in any appropriate sub-combinations.

What is claimed is:

1. A chopping apparatus including an actuator with a head portion at a first longitudinal end and a blade at a second longitudinal end, wherein said actuator is adapted to reciprocate along its longitudinal axis, and wherein a cushion member made of a material which is softer than the material of which said head portion is made is secured to said head portion of said actuator against relative movement therebetween.

2. An apparatus according to claim 1 wherein said cushion member is irremovable from said head portion.

3. An apparatus according to claim 1 wherein said cushion member is secured with said head portion of said actuator by ultrasonic moulding.

4. An apparatus according to claim 1 wherein said cushion member is made of a thermoplastic elastomer.

5. An apparatus according to claim 1 wherein said head portion of said actuator is made at least principally of acrylonitrile butadiene styrene resin.

6. An apparatus according to claim 1 further including a housing member for housing at least part of said actuator.

7. An apparatus according to claim 6 further including a base member releasably engageable with said housing member to form a chamber adapted to contain items to be chopped.

8. An apparatus according to claim 6 wherein said actuator is movable between a first position in which at least part of said blade is housed within said housing member and a second position in which said blade extends beyond said housing member.

9. An apparatus according to claim 8 further including a cover releasably engageable with said housing member to substantially cover said blade when said actuator is in said first position.
